(19) United States
(12) Patent Application Publication
(10) Pub. No.: US 2008/0137488 A1
(43) Pub. Date: Jun. 12, 2008

(54) TRANSMISSION CONFIGURABLE AND STORAGE CAPABLE AUDIO SYSTEMS AND LOUDSPEAKERS

(75) Inventor: Mark R. Friedman, Syosset, NY (US)

Correspondence Address: KELLEY DRYE & WARREN LLP, 400 ALTLANTIC STREET , 13TH FLOOR, STAMFORD, CT, 06901, US

(73) Assignee: Seal Systems, Syosset, NY (US)

(21) Appl. No.: 11/567,529

(22) Filed: Dec. 6, 2006

(51) Int. Cl. H04B 1/18

(52) U.S. Cl. 369/6; 369/5

(57) ABSTRACT

An audio system that allows audio to be stored and/or moved between components of the audio system by means of digital plug-in cards.

### BACKGROUND OF THE INVENTION

All references cited in this specification, and their references, are incorporated by reference herein where appropriate for teachings of additional or alternative details, features, and/or technical background.

1. Field of the Invention

The present invention generally relates to music audio systems having a plurality of components with one or more digital plug-in card portals accessible from the external face of each component allowing for replaceable insertion of one or more digital plug-in cards to allow for wireless communication between components of the system and/or to allow for storage of audio information.

2. Description of the Related Art

Home audio systems may be configured in various ways. In one common configuration, the audio system is self-contained as seen, for example, in a conventional table radio. Self-contained audio systems offer simplicity, but often do so at the expense of fidelity, and the ability to provide for expansion capacity of the system. It may be said that the lack of expandability, portability, ease of moving content and good fidelity within a self-contained system is the fundamental price paid for lower purchase price and ease of installation. In another configuration, the audio system comprises numerous distinct components such as tuners and loudspeakers. While distinct component audio systems often provide higher fidelity than self-contained systems, they typically do so at a considerably higher cost.

Non-contained audio systems, with their multiple chassis and abundant wires, have been hampered by their price, bulk, and complexity of connection, especially relating to upgradeability. With inputs and outputs for multiple external devices, the number of wires and cables can quickly overwhelm the average homeowner, especially now with five or more speakers providing surround theater-like sound. Notwithstanding the complexity of wiring the input components or local speakers, wiring a dwelling for multiple listening locations further complicates the system interconnectivity.

To provide audio in multiple rooms, a homeowner with a conventional system may be required to provide individual devices for each location in which the audio is desired to be heard. For those systems with some margin of expandability, such as a provision for external speakers, the undertaking can be costly to wire the dwelling for multiple speaker locations. Even after the expensive wiring is completed, one may find the receiver power output is too small to deliver sufficient power to effectively drive the loudspeakers in more distant locations. Additionally, the investment made in the wiring is lost if the homeowner relocates.

The playback medium (e.g., disk, tape) may be dedicated to a specific piece of player equipment in the audio system, such as a compact disk player, a phonograph player, or a tape player. The player may be connected to a central control unit, such as a pre-amplifier. The output from the central control unit may then be sent to a set of speakers via an amplifier at higher output power. New devices, known as portable digital media players (e.g., the iPod®), stimulated by the growth of digital content, and delivery, have gained favor with most listeners. Such digital media players allow audio data to be stored in the device and later broadcast without the need for employment of a specific playback medium. Digital audio lends itself well to portability and expanded delivery options as seen by the rampant growth in the market.

Ethernet technology, a computer network communication connectivity methodology, is now only beginning to make its way into small remote audio networks. Ethernet technology provides alternative transmission pathways of audio to remote speakers, versus traditional analog wires.

A wireless Ethernet audio transmission system is currently offered by Sonos as ZonePlayer®. ZonePlayer® differs from portable digital media players in that it does not store music itself, but instead relies on an existing music collection in a computer database, for example iTunes or a collection on a personal computer hard drive. In such a system, one unit is physically connected to a computer having access to the music collection database, and the other units receive the audio wirelessly therefrom. Control of the other units is by means of a remote control which needs to be only in range of one of the units as each unit relays the desired information to other units. Using such a system, one can send different streams of music to different rooms, link several rooms so that they all play the same music, and/or adjust volume with respect to each unit in one or more rooms.

U.S. Patent Publication No. 2002/0015362 describes a removable and interchangeable single-function and multi-function modules for use with a digital audio player. The multi-function interchangeable module interoperates with the body of the digital audio player to provide a plurality of features including additional memory storage, radio tuner, display infrared transceiver and wireless transceiver. The infrared transceiver and wireless transceiver provide the digital audio player with optional input and output devices so that the digital audio player can wirelessly exchange data or programs with other devices. The module may be exchanged in order to change the functionality of the digital audio player.

Employment of wireless Ethernet audio transmission systems such as ZonePlayer® and interchangeable multi-function modules in digital audio players may present drawbacks to consumers. Wireless Ethernet components as seen in ZonePlayer® are statically constructed permitting little, if any, flexibility with respect to the signals received and broadcast by the components in each room. Interchangeable modules as described in U.S. Patent Publication No. 2002/0015362 are designed solely to fit, adapt and complete the components of a solitary personal audio player. What is needed is a more flexible audio system that permits multiple components in the system to be easily reconfigured to receive and broadcast a multiplicity of signals. Further, it would be advantageous if signals could be stored at more sites in the system, that is, at multiple components in the system, without the need to physically download data into each.

### SUMMARY OF THE INVENTION

Embodiments disclosed herein include:

In one embodiment, there is disclosed an audio system comprising one or more audio components configured to convert an electromagnetic signal to an audio signal comprising one or more digital plug-in slots operably configured to replaceably interchange of one or more digital plug-in cards; one or more digital plug-in cards having wireless signal receiving capability positioned in the one or more slots; and a central controller, remote from the one or more audio components configured to transmit a control signal to the one or more digital plug-in cards having wireless signal receiving capability.

In another embodiment, there is disclosed an audio device comprising a receiver operatively configured to receive and process electromagnetic transmissions encoding audio information; one or more speakers operatively connected to the receiver configured for broadcasting audio information encoded in the electromagnetic transmissions; and one or more digital plug-in slots adapted for interacting with a digital plug-in card, the plug-in slots connected to the receiver.

### BRIEF DESCRIPTION OF THE DRAWINGS

FIG. 1 illustrates a partial cutaway perspective view the front surface of a loudspeaker cabinet.

FIG. 2 shows a perspective rear view of a loudspeaker with a card slot.

FIG. 3 shows a perspective front view of a receiver, such as a table top radio with controls and internal speakers.

FIG. 4 illustrates a perspective view of the rear of a receiver with multiple card slots.

FIG. 5 is a block diagram representation of an audio system with multiple slots and communication cards.

FIG. 6 is a block diagram of an audio system with remote components.

### DETAILED DESCRIPTION OF THE INVENTION

There is disclosed herein an audio system that allows audio to be stored and/or moved between components of the audio system by means of wireless digital plug-in cards that are removably replaceable in one or more components of the system. The digital plug-in cards may be configured with data storage capability allowing components, such as loudspeakers, not normally associated with data storage capability to store music and operate as music servers. In one embodiment, one or more components, of the system comprise digital slots that are found on one or more surfaces of the component, for example, the back surface. The digital plug-in cards may comprise computer industry standard connectors, such as standard PCMIA cards. The cards may be configured to contain circuitry allowing for the cards' reception and or transmission of certain wireless signals if the component itself does not contain structure permitting the same.

An audio system of the invention may employ an operating system such as Linux or the Microsoft Operating System. The operating system is selected to allow for the recognition of the digital plug-in cards. For example, loudspeakers in the system may comprise standard protocol Ethernet cards or wireless plug-in cards that interact in the system in a Linux environment. Such loudspeakers may comprise circuitry allowing for receipt of transmissions internally, or may obtain the ability to receive such transmissions by means of the digital plug-in card. That is, the plug-in cards may be recognized by the component and allowed to receive and/or transmit audio to other locations, store audio, and/or move audio libraries from one location to another. In one embodiment, the entire system may be controlled using an RF enabled remote control which may duplicate, for example, the screen display and user interface found on one the controller of the system, or electronic products that are part of the system.

An audio system of the present invention may allow for high performance audio, home theatre, radio, loudspeakers and other components known to those skilled in the audio art. It may also allow for simple, wireless, and affordable broadcast of music and stored music libraries to other locations. Wireless transmission of audio from room to room and component to component becomes possible after the card(s) are installed. Transmission may be by any protocol, for example the IEEE 802.11x standards family.

In one embodiment, the audio system may allow slots operatively configured for use with hard drive digital-plug-in cards comprising: standard hard drives, or mini hard drives. In addition to the playing audio from the hard drives, the hard drives may allow use for the storage of audio or audio libraries; wherein the storage may facilitate the portable transport of audio files from one system to another by, for example, loading the drive with audio content or audio libraries, removing the drive and inserting the drive into another system. Further to this embodiment, a system comprising two slots may provide provisions to move or copy audio content or audio libraries from one hard drive to another hard drive. An alternative further embodiment may provide for the transfer of audio content or audio libraries to the hard drive digital-plug-in card from an alternative digital-plug-in card occupying an additional slot, such as for example, a wireless IEEE 802.11b card. Audio content and/or audio libraries may alternatively be downloaded, for example, from a wireless source, such as an XM satellite radio digital-plug-in card and stored on the hard drive digital-plug-in card.

The digital plug-in cards may comprise cards such as flash drives, hard drives, USB drives etc. which are recognized by the component and allow, for example, the download, storage, and access of music from various sources, such as, but not limited to, AM radio, FM radio, compact disks, flash cards, other hard drives, XM Satellite radio, Sirius Satellite radio and iBiquity digital radio.

Components of the audio system may comprise by way of the plug-in cards the ability to play, store, and/or broadcast, for example, AM radio, FM radio, XM Satellite radio, Sirius Satellite radio, iBiquity digital radio, weather and emergency band radio and data on compact disks, DVDS, MP-3 players, flash memory cards, and USB devices.

As would be understood by one in the art, such systems may permit easy expandability of an audio system and improve portability and ease of moving content.

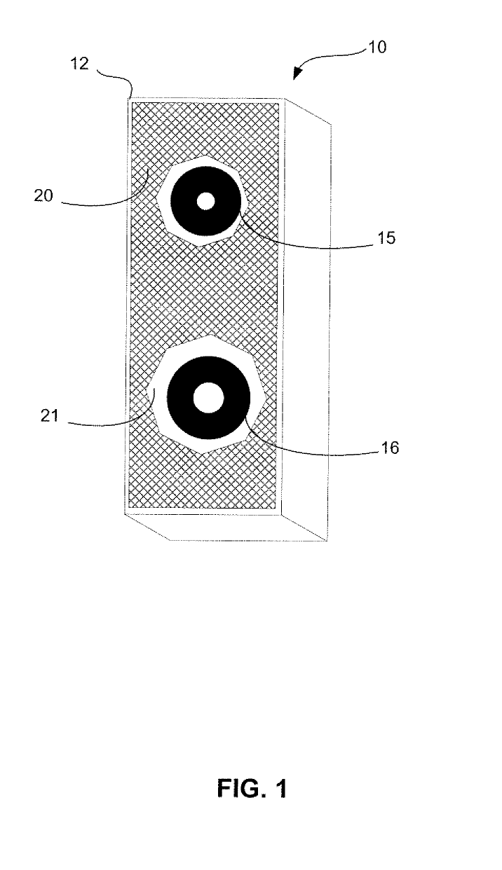

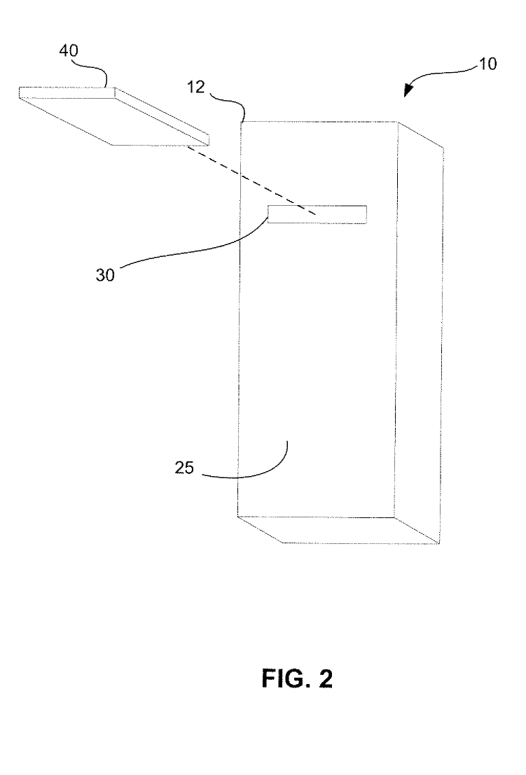

FIG. 1 and FIG. 2 illustrate parametric views of a loudspeaker which may find use in one embodiment of the invention. The front view of loudspeaker 10 is depicted in FIG. 1. As shown, loudspeaker 10, can comprise solid housing 12 defining a void in which the electronics of the loudspeaker are housed. Loudspeaker 10, as illustrated, includes removable front face panel 20, which allows for access to the electronics within the housing. Such electronics may include one or more speakers such as tweeter 15 and woofer 16, mounted to front surface 21. FIG. 2 depicts a hack view of loudspeaker 10. Loudspeaker 10 includes on its back surface 25 one or more digital plug-in card slots 40 configured to receive one or more industry standard digital plug-in cards. While not shown, loudspeaker 10 may also include a data storage device that allows for storage of signals/data received in conjunction with a processor that allows such stored data to be retrieved and played. In a further embodiment, loudspeaker 10 may include the ability to re-broadcast stored signals to other components in the system.

By digital plug-in card, it is meant to include any digital processing and/or any digital storage card, including without limitation, a flash memory card, an Ethernet card, a hard drive memory card, and a wireless transceiver card. In one embodiment, the card used permits wireless communication with other components of the system which may or may not employ similar cards in its slots.

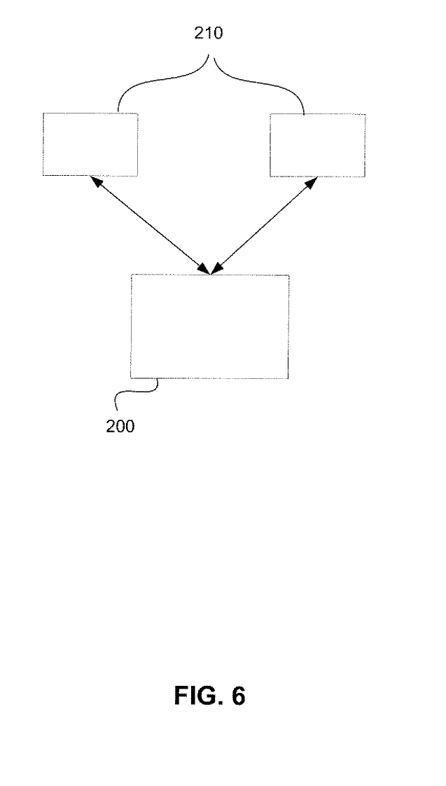

The audio system may include, as shown in FIG. 6 a control receiver 200 and a number of remote components 210 designed to receive signals from the control receiver. Control receiver 200, for example, may be adapted to receive a digital plug-in card for a simple AM and/or FM signal. The components remote to the central control system, for example the loudspeakers, may each be supplied with one or more digital plug-in card slots. Changing the digital plug-in card may allow alteration of the frequency or signals which it receives from the controller. With such a system, a listener in one room may be allowed to access a signal transmitted by the controller and associated with one form of audio, say that received by a Sirrus radio card. Simultaneously, another listener in another room may effectively access audio transmitted by the same controller, yet the signal may be associated with an FM source, possibly provided by yet another card. If the digital plug-in cards are selected as to allow for two-way communication with the controller, and the controller is operatively configured to allow for receipt of data from such components, a person in one room may request via direct or wireless interaction with the component that the component send a signal to the controller to affect the particular source or signal being received (e.g., providing control signals to the controller to tune to another FM station or select and alternate audio source, such as for example, the hard drive card).

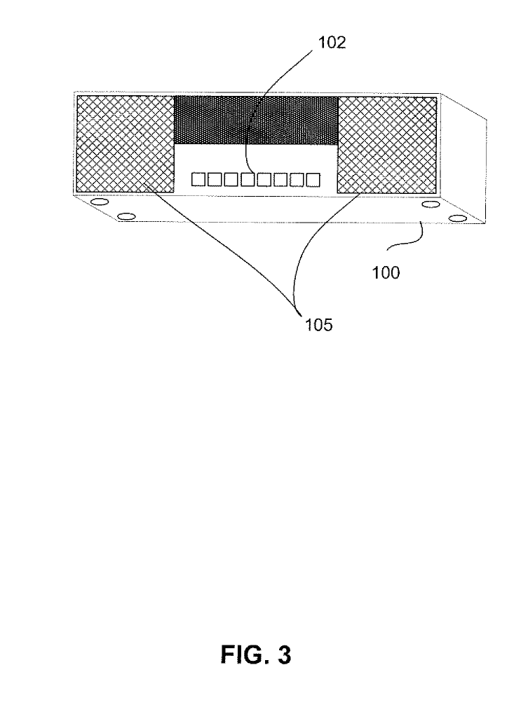

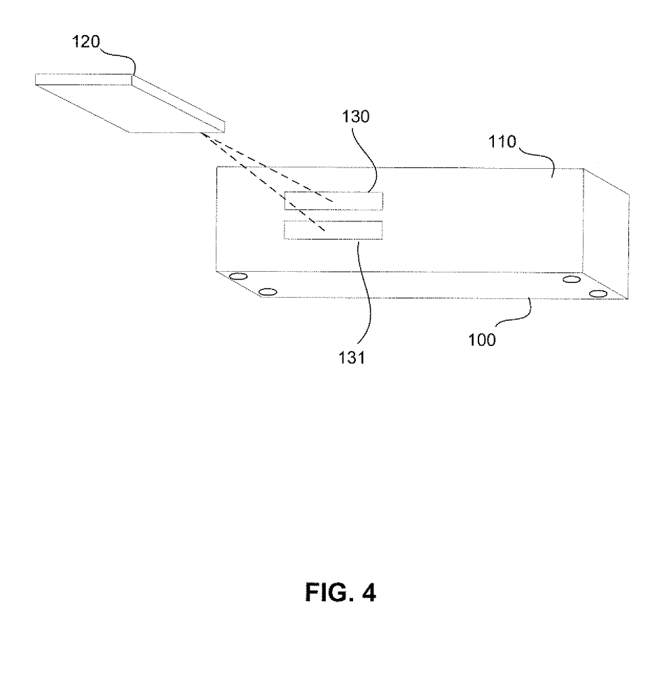

In another embodiment of the present invention, the system comprises a single component without remote component interface. Such an embodiment is illustrated in FIGS. 3 and 4. These figures show, respectively, the front and back view of a table top receiver 100. As shown in FIG. 3, table top receiver 100 includes speakers 105 and frequency signal receipt controls 102. Back panel 110 includes a plurality of digital plug-in card slots, each designed for adaptation with one or more digital plug-in cards 120 which affect the functionality of table top receiver with respect to its processing of received signals and/or transmission of signals. By changing the digital plug-in card interfaced with table top receiver 100, one can alter its functionality, for example, allowing it to receive signals which it could not previously have received, and/or store data it could not have previously stored. The table top receiver of the present embodiment may provide audio in the form of digital signals received from a Sirrus satellite radio card, or hard drive.

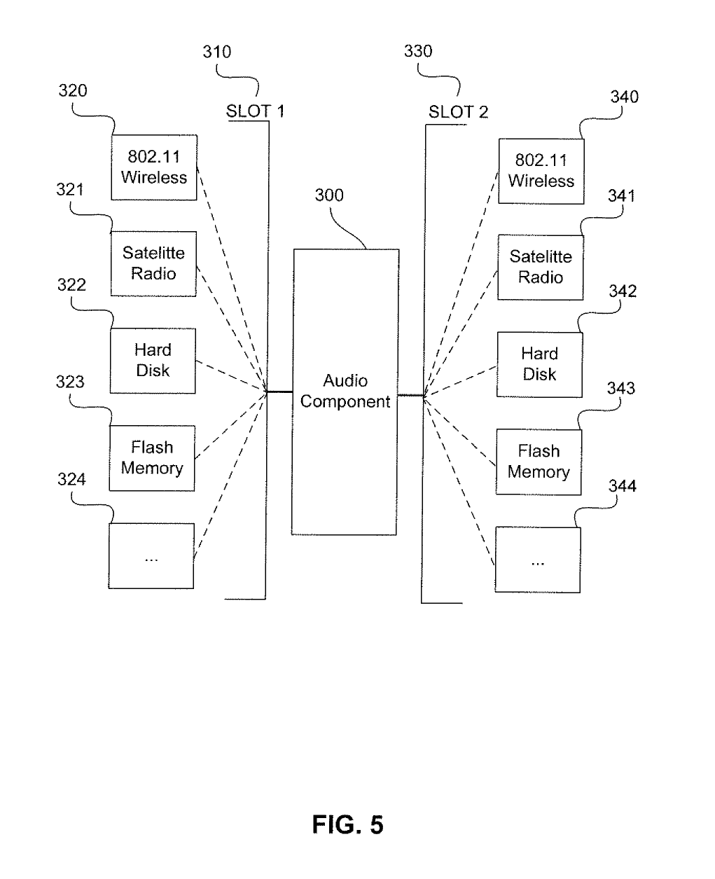

Now turning to FIG. 5, there is shown an exemplary block diagram of an audio system capable of accepting one or more digital plug-in communication cards. In this illustration, the audio component 300 provides slots 310 and 330 to which cards comprising 802.11 wireless cards 320 and 340, satellite radio cards 321 and 341, hard disk cards 322 and 342, or flash memory cards 323 and 343, may be loaded.

One possible embodiment may involve transferring content from one plug-in card to another, such as selecting hard disk 322 and 342, wherein the user could move, copy or otherwise manipulate data or content between the two hard disks. Another possible embodiment might be to receive content from flash memory card 323 and broadcast it to speakers (not shown) via a wireless method, such as 802.11 wireless card 340.

While the invention has been described with respect to preferred embodiments, those skilled in the art will readily appreciate that various changes and/or modifications can be made to the invention without departing from the spirit or scope of the invention as defined by the appended claims. All documents cited herein are incorporated by reference herein where appropriate for teachings of additional or alternative details, features and/or technical background.

1. An audio system comprising:
one or more audio components configured to convert an electromagnetic signal to an audio signal comprising one or more digital plug-in slots operably configured to replaceably interchange one or more digital plug-in cards;
one or more digital plug-in cards having wireless signal receiving capability positioned in said one or more slots; and
a central controller, remote from said one or more audio components, and configured to transmit a control signal to said one or more digital plug-in cards having wireless signal receiving capability.

2. The audio system of claim 1 wherein the digital plug-in card is a PCMIA card.

3. The audio system of claim 1 wherein the audio component is a loudspeaker.

4. The audio system of claim 1 wherein the central controller is a digital media player.

5. The audio system of claim 1 wherein the central controller is a digital media server.

6. The audio system of claim 1 wherein the control signal controls the audio played on the audio component.

7. The audio system of claim 1 wherein the control signal controls the audio stored on the audio component.

8. An audio device comprising:
a receiver operatively configured to receive and process electromagnetic transmissions encoding audio information;
one or more speakers operatively connected to said receiver configured for broadcasting audio information encoded in said electromagnetic transmissions; and
one or more digital plug-in slots adapted for interacting with a digital plug-in card, said plug-in slots connected to said receiver.

9. The audio device of claim 8 wherein the receiver is a radio transmission receiver.

10. The audio device of claim 8 comprising two or more speakers.

11. The audio device of claim 10 wherein the audio device produces stereo sound.

12. The audio device of claim 8 wherein the digital plug-in card slot is adapted for receipt of a PCMIA card.

13. The audio device of claim 8 wherein the digital plug-in card slot is adapted for receipt of a Sirius radio card.

14. The audio device of claim 8 wherein the digital plug-in card slot is adapted for receipt of an Ethernet card.

15. The audio device of claim 8 wherein the digital plug-in card slot is adapted for receipt of a wireless transceiver card.

16. The audio device of claim 8 wherein the digital plug-in card slot is adapted for receipt of a flash memory card.

17. The audio device of claim 8 wherein the digital plug-in card slot is adapted for receipt of a hard drive card.
